(19) United States
(12) Patent Application Publication
(10) Pub. No.: US 2011/0285583 A1
(43) Pub. Date: Nov. 24, 2011

(54) PERCEPTIVE GLOBAL POSITIONING DEVICE AND METHOD THEREOF

(75) Inventors: Jiung-Yao Huang, Taoyuan (TW); Chung-Hsien Tsai, Chia Yi (TW)

(73) Assignee: Jiung-Yao Huang, Taoyuan City (TW)

(21) Appl. No.: 12/881,606

(22) Filed: Sep. 14, 2010

(30) Foreign Application Priority Data
May 20, 2010 (TW) 099116057

(51) Int. Cl. G01S 19/40

(52) U.S. Cl. 342/357.23

(57) ABSTRACT

A perceptive global positioning device is disposed on or carried by a carrier (vehicle, pedestrian, etc.) for receiving positioning signals transmitted from satellites, to detect various behavioral states related to movement and correct errors in positioning data for positioning the carrier. The positioning device includes a sensor for receiving positioning data related to the global position of the carrier transmitted from satellites, a database for storing the positioning data received by the sensor and a preset behavioral transition matrix of the carrier, an analysis module for analyzing the positioning data and behavioral transition matrix to obtain predictable behavior data, and a correction module for comparing the predictable behavior data with the positioning data so as to correct errors of the positioning data of the carrier, thereby overcoming the defect of inaccurate data as encountered in the prior art.

### BACKGROUND OF THE INVENTION

1. Field of the Invention

This invention relates to a perceptive global positioning device and method thereof, and more particularly, to a perceptive global positioning device for more accurately positioning the position of a carrier, such as a vehicle or pedestrian, and method thereof.

2. Description of Related Art

Conventional navigation technique can establish the approximate position of a carrier. Although various navigation techniques have been developed, these navigation techniques still suffer from certain defects. For example, the landmark-based technique will cause navigation errors if landmarks are erroneously marked; the dead reckoning technique easily generates accumulative errors over time, resulting in its navigation accuracy being significantly diminished; the celestial navigation technique accomplishes positioning by viewing the location of celestial bodies, but a tiny measured error in the angle to a celestial body will result in a large positioning error because the measured carrier is always at a great distance from celestial bodies; the inertial navigation technique, which perceives the location of the carrier by measuring the second derivative of an inertial acceleration, also is subject to accumulative errors; and the radio navigation technique, which utilizes a fixed-point radio wave-emitting source to perform navigation, has difficulty in establishing reception rules to compensate for complicated errors attributed to radio wave transmission being easily affected by topography.

A global position system (GPS) is one of the most advancing positioning techniques. The GPS navigation system still contains errors with regard to positioning. The errors are generally categorized into environmental phenomenon errors, ranging errors and receiver errors. As for a GPS receiver, these aforesaid errors are inevitable. Thus, the GPS positioning data have to be calibrated. GPS calibration may be categorized into an absolute positioning technique and relative positioning techniques, with regard to time and space effects. The absolute technique may solve the time variations of GPS satellite signals. The absolute technique employs a differential GPS technique which uses a reference station to broadcast wireless signals to a GPS receiver. However, the absolute technique has a disadvantage in that it demands costly infrastructure to be provided. The relative positioning techniques may be subdivided into relative auxiliary navigation equipment techniques and relative software navigation techniques. The auxiliary inertial navigation equipment is easily influenced by gravity and bring about accumulative errors. The AGPS approach utilizes the existing mobile phone based stations to obtain up-to-date so-called ephemeris extensions to expedite the time to first fix (TTFT) to accelerate the overall positioning time. However, the AGPS technique cannot improve the positioning accuracy. The relative software navigation operation includes Kalman filter, dead reckoning (DR) and map matching methods. These relative software navigation operation techniques have inherent limitation and have to be applied under certain conditions. Accordingly, there is still no way to solve the positioning error problem. Therefore, the current GPS navigation techniques heavily count on hardware support and ignore the contextual information of GPS data. Accordingly, it is important to find a positioning technique that may reduce external error effects.

Therefore, finding a device and method that may predict movement behaviors of a carrier to correct errors involving the positioning data associated with the location of the carrier is highly desirable in the art, in order to prevent the received positioning data (e.g., GPS positioning data) from exhibiting too great a drift error due to environmental effects, improve the accuracy of the positioning data through behavior prediction for movement of the carrier, and solve the problem of the prior art that accumulative errors caused positioning errors.

### SUMMARY OF THE INVENTION

In view of the above-mentioned problems of the prior art, the present invention provides a perceptive global positioning device that is carried on/by a carrier, for receiving positioning signals transmitted from satellites, in order to detect movement behavior states of the carrier and correct errors in positioning data of the carrier, the perceptive global positioning device comprising: a sensor for receiving positioning data related to the location of the carrier transmitted from satellites; a database for storing the positioning data received by the sensor and a preset behavioral transition matrix of the carrier; an analysis module for analyzing the positioning data and the behavioral transition matrix, to acquire predictable behavior data of the carrier; and a correction module that compares the predictable behavior data of the carrier with the positioning data, to correct errors in the positioning data of the carrier.

The present invention further provides a perceptive global positioning method, for determining consecutive behavior states of a carrier through positioning signals transmitted from satellites and correcting errors of the positioning data, the method comprising the following steps of: (1) receiving positioning data transmitted from satellites to the carrier; (2) analyzing the positioning data to obtain feature data of the positioning data; (3) analyzing two predecessors of the received positioning data and a preset behavioral transition matrix to obtain predictable behavior data; and (4) comparing the positioning data with the predictable behavior data to calculate an error value, and correcting the positioning data according to the error value.

Compared with the prior art, the present invention provides a perceptive global positioning device that, after receiving positioning data transmitted from a satellite, calculates possible behavior states of the carrier through an optimal behavioral transition matrix, determines an error value between the currently received positioning data and possible behavior information, and corrects errors in the positioning data. By adding the sense data analysis of the carrier, the predictable behavior states of the carrier may be obtained and compared with the received data to determine errors. The errors may be corrected based on the comparison results and the accuracy of positioning effect may be improved accordingly. Hence, the problems of the conventional global positioning equipment may be addressed to overcome low accuracy because of environmental factors and equipment factors. Through the perceptive global positioning method of the present invention, only the feature data of the behavior states of a carrier are extracted, which avoids the problems of the prior art that adds navigation equipment, resulting in increased costs and introduced errors. In the present invention, the received positioning data are examined through the prediction of behavior states of a carrier, and the error conditions are also corrected. Therefore, the global positioning accuracy is greatly improved.

### BRIEF DESCRIPTION OF DRAWINGS

The invention can be more fully understood by reading the following detailed description of the preferred embodiments, with reference made to the accompanying drawings, wherein:

FIG. 1 is a functional block diagram of a perceptive global positioning device according to the present invention;

FIG. 2 is a functional block diagram of an analysis module of a perceptive global positioning device according to the present invention;

FIG. 3 is a functional block diagram of a correction module of a perceptive global positioning device according to the present invention;

FIG. 4 is a polar graph illustrating how a perceptive global positioning device corrects errors of positioning data according to the present invention; and

FIG. 5 is a flowchart illustrating how to generate a behavioral transition matrix in the perceptive global positioning method.

### DETAILED DESCRIPTION OF PREFERRED EMBODIMENTS

The following illustrative embodiments are provided to illustrate the disclosure of the present invention and advantages thereof, wherein these and other advantages and effects can be readily understood by those in the art after reading the disclosure of this specification. The present invention can also be performed or applied by other embodiments. The details of the specification are on the basis of particular points and applications, and numerous modifications and variations can be devised without departing from the spirit of the present invention.

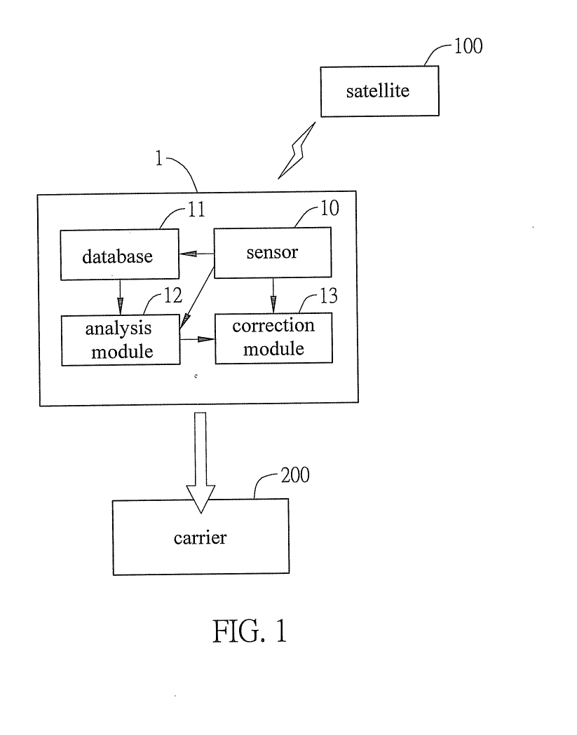

FIG. 1 is a functional block diagram of a perceptive global positioning device 1 according to the present invention. The perceptive global positioning device 1 receives positioning signals transmitted from satellites 100, using the signals to determine behavior states of a carrier 200 to thereby correct errors in the positioning data of the carrier 200. The perceptive global positioning device 1 comprises a sensor 10, a database 11, an analysis module 12 and a correction module 13. Note that the perceptive global positioning device 1 is installed in or disposed on the carrier 200, for receiving the positioning signals transmitted from the satellite 100 and processing the positioning data. The satellite technology for transmitting and receiving the positioning signals is prior art, so further description thereof is omitted. The carrier 200 may be a vehicle, such as a car, plane or boat, but is not limited to be a vehicle. The carrier 200 may be any movable object or creature, including robots, humans or animals.

The sensor 10 receives the positioning data of the carrier 200 transmitted from the satellite 100.

The database 11 stores the positioning data received by the sensor 10 and a preset behavioral transition matrix of the carrier 200. All the positioning data that the sensor 10 receives is stored in the database 11, for the purpose of subsequent behavior prediction and positioning correction. The database 11 stores the behavioral transition matrix that is used for predicting behavior states. The behavioral transition matrix is used for predicting, based on the positioning data, the next possible behavior, that is, the next possible behavior of the carrier 200, allowing the predicted behavior to be compared with the positioning data. The database 11 may store a plurality of behavioral transition matrixes, which are generated in accordance with various behavior states of the carrier 200 for behavior prediction purposes.

The analysis module 12 analyzes the positioning data and the behavioral transition matrix, to obtain predictable behavior data of the carrier 200. The analysis module 12 analyzes and calculates the positioning data received by the sensor 10 and the behavioral transition matrix, to obtain the predictable behavior data through the behavioral transition matrix. The next possible behavior state may be obtained through the received positioning data and the behavioral transition matrix, for comparison with subsequently-received positioning data.

The correction module 13 compares the predictable behavior data of the carrier 200 with the positioning data, thereby correcting errors of the positioning data of the carrier 200. As mentioned, the analysis module 12 obtains the predictable behavior data of the carrier 200, and then the correction module 13 compares the positioning data with the predictable behavior data, the predictable behavior data being obtained by predicting preceding behaviors, to thereby position the carrier 200 and correct the errors of the positioning data.

The behavioral transition matrix that the analysis module 12 analyzes is formed from feature data of a plurality of positioning data. In other words, the behavioral transition matrix is formed from a plurality of behavior data of a carrier, and different behavior states correspond to different behavioral transition matrixes, such that behaviors may be detected under various behavior states.

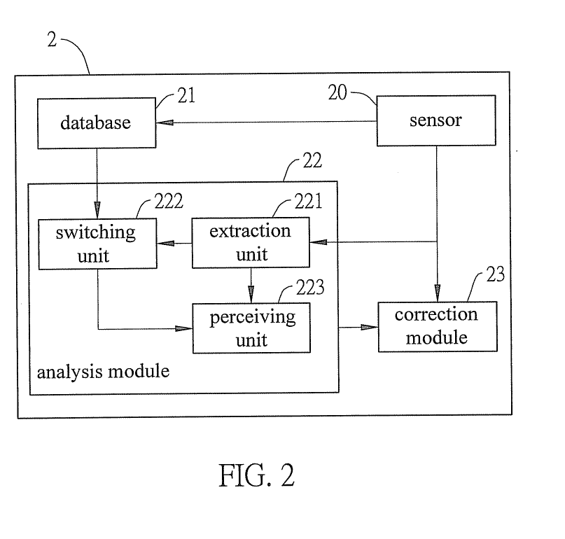

FIG. 2 is a block diagram of an analysis module of another perceptive global positioning device 2. The perceptive global positioning device 2 comprises a sensor 20 that receives positioning data transmitted from satellites, a database 21 that stores the positioning data and a behavioral transition matrix for analysis purposes, an analysis module 22 that analyzes the positioning data, and a correction module 23 that corrects the positioning data. In the embodiment, the analysis module 22 comprises an extraction unit 221, a switching unit 222 and a perceiving unit 223.

The extraction unit 221 extracts data of the positioning data received by the sensor 20. Since the received positioning data includes much satellite signal information, such as time, location, direction, velocity, the satellite in use or satellite information, the extraction unit 221 extracts from the positioning data important information that is used for carrier navigation analysis. The important information is referred to as feature data in the present invention.

The NMEA 0183 format is used in the present invention, which has at least ten sentences for providing data corresponding to a satellite. In the embodiment, the sentences that provide important information include GPRMC, GPGGA, GPGSA and GPGSV, and their main contents include the basic information needed for positioning navigation, such as time, location, direction, speed, GPS operation mode, satellite in use and its DOP value, the number of visible satellites, satellite ID and signal-to-noise ratio (SNR).

Since the received positioning data is GPS digital data collected in an instant, which also represents a motion state of a carrier at that instant, the positioning data may be deemed as single-point location information. A motion trajectory of the carrier may be formed by delineating a plurality of continuous positioning data. However, the instant data of every point in the motion trajectory, such as location, speed and orientation, may not provide complete motion information. Newton's second law of motion

$$F = \frac{d ( mv )}{d t}$$

is thus applied to calculate the change of the carrier. The behavior change of the carrier may be obtained through the displacement, velocity difference and course difference of two received positioning data sets, which constitutes the required feature data for context awareness.

The switching unit 222 analyzes the feature data according to a carrier habitual behavior determination rule, to switch a threshold corresponding to the feature data of the carrier habitual behaviors and a behavioral transition matrix corresponding to the carrier habitual behaviors. When the carrier 200 is in different motion states, different behavioral transition matrixes have to be used for predicting the current behaviors. Accordingly, the switching unit 222 determines the feature data extracted from the positioning data according to the determination rule, to obtain the carrier habitual behaviors that are the behavior states of the carrier. Then, a behavioral transition matrix is acquired from the database 21 that is the most appropriate one to perceive the predictable behavior data of the carrier and a threshold of difference between the feature data, for allowing the perceiving unit 223 to analyze and perceive.

The perceiving unit 223 analyzes behavior states of two predecessors of positioning data received by the sensor 20, and calculates the predictable behavior data through the behavioral transition matrix. The perceiving unit 223 perceives the predictable behavior data through the feature data extracted by the extraction unit 221. The feature data of two positioning data sets is used to perceive possible behavior states of the next positioning data. The database 21 stores a plurality of behavioral transition matrixes, allowing the perceiving unit 223 to calculate the predictable behavior data.

The present invention perceives the behaviors of a carrier through feature data of the behaviors of the carrier. The aforesaid velocity difference Δv plays an important role when a momentum change is used to determine the motion of the carrier, the displacement Δx is an important basis for determining drift errors, and the course difference Δθ provides an orientation change. As a result, the computed feature data, (Δx, Δv, Δθ), obtained from the positioning data of the carrier may be used to classify the behavior states of the carrier. The analysis module 22 classifies the behavior states of the carrier into seven models:

(1) The stationary model (Sₛ): both the displacement (Δx) and the velocity difference (Δv) are very small, and a threshold is defined; a carrier is classified into the stationary state when both the received displacement and velocity difference are smaller than the threshold;

(2) The linear cruise model (SO: linear cruise means that the displacement (Δx) of the carrier is constant, and both the velocity difference (Δv) and the course difference (Δθ) are smaller than a threshold value; a carrier is classified into the linear cruise state when both the received velocity difference and course difference are smaller than a threshold, but the difference between two consecutive displacements is less than a threshold value;

(3) The linear acceleration model (Sₗₐ): linear acceleration means the displacement (Δx) and velocity difference (Δv) of the carrier are incremental, and the course difference (Δθ) is smaller than a threshold; a carrier is classified into the linear acceleration state when the difference between two consecutive displacements is greater than a threshold, the velocity difference is greater than a threshold, and the course difference is less than a threshold;

(4) The linear deceleration model (S_{ld}): linear deceleration means that the velocity difference (Δv) of the carrier has decreased progressively, the displacement (Δx) is incremental, and the course difference (Δθ) is less than a threshold; a carrier is classified into the linear deceleration state when the absolute value of the difference between two consecutively received displacements is greater than a threshold, the velocity difference is negative, the absolute value of the velocity difference is greater than a threshold value, and the course difference is less than a threshold;

(5) The veering cruise model (S_{vc}): veering cruise means that the displacement (Δx) of the carrier is constant, the velocity difference (Δv) is less than a threshold, and the course difference (Δθ) is greater than a threshold; a carrier is classified into the veering cruise state when the received velocity difference is less than a threshold, the difference between two consecutive displacements is less than a threshold value, and the course difference is greater than a threshold;

(6) The veering acceleration model (Sᵥₐ): veering acceleration means that both the displacement (Δx) and velocity difference (Δv) of the carrier are incremental, and the course difference (Δθ) is greater than a threshold; a carrier is classified into the veering acceleration state when the difference between two consecutively received displacements is greater than a threshold, and both the velocity difference and course difference are greater than a threshold; and

(7) The veering deceleration model (S_{vd}): veering deceleration means that the velocity difference (Δv) of the carrier has decreased progressively, the displacement (Δx) is incremental, and the course difference (Δθ) is greater than a threshold; a carrier is classified into the veering deceleration state when the absolute value of the difference between two consecutive displacements is greater than a threshold, the displacement is negative, the absolute value of the displacement is greater than a threshold, and the course difference is greater than a threshold value.

Since the behavior states (motion states) of a carrier will change with time, transitions among the states have to be deduced through Newton's three laws of motion, which include the law of inertia (N1), the law of acceleration (N2), and the law of reciprocal actions (N3). Table 1 shows possible behavior states that a carrier generates in various motion states under Newton's laws of motion.

TABLE 1
Motion State Transitions

| | Sₛ | Sₗₐ | S_{lc} | S_{ld} | Sᵥₐ | S_{vc} | S_{vd} |
|---|---|---|---|---|---|---|---|
| N1 | Sₛ | X | S_{lc} | X | X | S_{vc} | X |
| N2 | Sₗₐ, Sᵥₐ | Sₗₐ, Sᵥₐ | Sₗₐ, Sᵥₐ, | Sₗₐ, Sᵥₐ, | Sₗₐ, Sᵥₐ | Sₗₐ, Sᵥₐ, | Sₗₐ, Sᵥₐ, |
| | | | S_{vc} | S_{lc}, S_{vc} | | S_{lc} | S_{lc}, S_{vc} |
| N3 | X | S_{ld}, S_{vd}, | S_{ld}, S_{vd}, | S_{ld}, S_{vd}, Sₛ | S_{ld}, S_{vd}, | S_{ld}, S_{vd}, | S_{ld}, S_{vd}, |
| | | S_{lc}, S_{vc} | S_{vc} | | S_{lc}, S_{vc} | S_{lc} | Sₛ |

For example, if the current state is the stationary state (Sₛ), its next state does not exist, as denoted by X, when considering Newton's law of reciprocal actions (N3); and if the carrier is in the linear acceleration state (Sₗₐ), and is acted upon by Newton's law of reciprocal actions (N3), its next behavior state can be any one state of linear deceleration S_{ld}, veering deceleration S_{vd}, linearly cruise S_{lc} and veering cruise S_{vc}.

According to the aforesaid transitions among the behavior states, a Newton Markov Model (NMM) is applied to deduce transition probability. The NMM is a model that expresses a transition relation among behavior states in a probability manner by considering previous behavior states. To facilitate the following discussion, the state sequence of a carrier is expressed as {Sᵢ}, wherein i indicates a discrete instance of time and Sᵢ ∈ S at any discrete instance of time. In an embodiment, the equation P(Sₜ=j|Sₜ₋₁=i) indicates the transition probability between the behavior states, that is, the probability of state i at time t-1 transitioning to state j at time t. For example, P(Sₜ=Sₗₐ|Sₜ₋₁=Sₗₐ) represents the probability of the state Sₗₐ at time t-1 transitioning to the state Sₗₐ at time t.

If it is assumed that a carrier contains N behavior states, an N×N transition probability matrix (TPM) may be used to represent the behavior states of the carrier. The transition probability matrix may be formulated by equation (1).

TPM={P(Sₜ=j|Sₜ₋₁=i)_{N×N}=[A_{i,j}(t)]_{N×N} (1)

where Aᵢⱼ(t)=P(Sₜ=j|Sₜ₋₁=i), and N is the number of states. Therefore, if Aᵢⱼ(t) can be computed beforehand, the current behavior state of the carrier can then be inferred from the previous state and the TPM. In conclusion, the transition probability matrix (TPM) can be obtained by the accumulation of the behavior state information and the NMM and known behavior information. The current possible behavior states of the carrier can then be deduced from the received positioning data by the transition probability matrix (TPM) and the previous behavior states of the carrier. Note that the transition probability matrix is called a behavioral transition matrix in the present invention.

Moreover, different observation sequences may indicate that the behaviors of the carrier have changed. Therefore, when a change between two consecutive observation sequences does not exceed a threshold of errors, it implies that the behavior states of the carrier are stable habitual behaviors. Accordingly, the transition probability matrix may be called a stable TPM or an optimal TPM. In other words, the switching unit 222 determines and finds out, through the habitual behaviors of the carrier, a behavioral transition matrix that is most suitable to analyze the behaviors of the carrier, such that the carrier may have more accurate predictable behaviors.

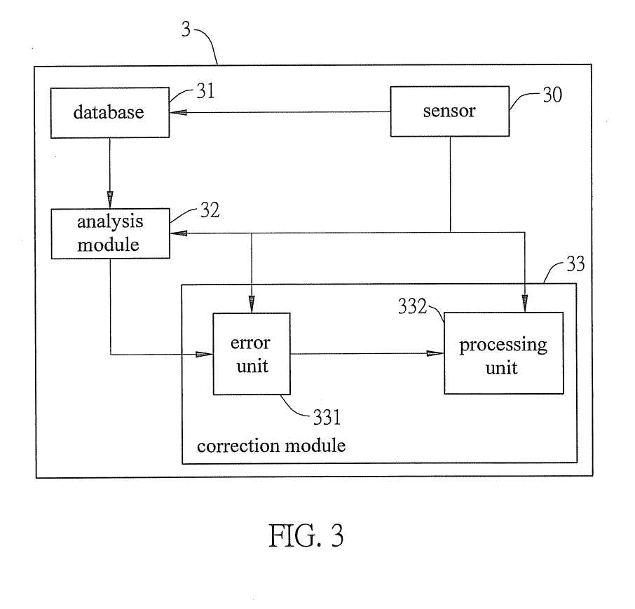

FIG. 3 is a functional block diagram of a correction module 33 of a perceptive global positioning device 3 according to the present invention. The perceptive global positioning device 3 comprises a sensor 30, a database 31, an analysis module 32 and a correction module 33 that has the same functions as shown in FIG. 1. In the embodiment, the correction module 33 comprises an error unit 331 and a processing unit 332.

The error unit 331 calculates an error value of the positioning data according to the predictable behavior data. The perceiving unit 223 of FIG. 2 perceives based on the two predecessors of the received positioning data and the behavioral transition matrix, and the known predictable behavior data are used for the error unit 331 to determine errors of the predictable behavior data and the positioning data, to obtain the received positioning data and predictable behavior data perceived from previous positioning data.

The processing unit 332 corrects errors of the positioning data according to the error value. Simply speaking, the processing unit 332 corrects errors of the received positioning data according to the error value of the error unit 331, allowing the carrier to have more accurate navigation positioning.

Through the optimal transition probability matrix (stable TPM), as shown in equation (2), i.e., the transition matrix of the present invention, the current state k with the maximum probability may be obtained from two consecutive states i and j, as shown in equation (3).

$$\begin{matrix}T P M = {[ P ( {S}_{t} = k \vert {S}_{t - 2} = i \& {S}_{t - 1} = j ) ]}_{N \times N} = {[ {A}_{i , j , k} ( t ) ]}_{N \times N \times N} & ( 2 ) \\ P ( {S}_{k} \vert TPM , {S}_{i} , {S}_{j} ) = {arg max \{ {A}_{i , j , k} ∀ k \}}_{given i , j} & ( 3 )\end{matrix}$$

which represents that the predictable current state k takes k with the maximum probability A_{i,j,k} ∀ k, given i, j as the next behavior state, under state i, state j and the optimal transition probability matrix.

In practice, the analysis module 32 generates at least one determination result, and the processing unit 332 corrects errors for corresponding positioning according to different determination results. However, though the possible behavior states are perceived based on the maximum probability method, the obtained determination result may still has some problems because the positioning data may have errors caused by environment effects, the motion states of the carrier have changed, the prediction of the current state is incorrect, and/or the habitual behavior of the carrier has changed.

Regarding the erroneous conditions generated due to different causes, the correction module 33 uses the extracted feature data to generate current behavioral data, compares the current behavioral data with the predictable behavior data, and corrects the positioning data of the carrier if the current behavioral data are equal to the predictable behavior data, or selects one of the current behavioral data and the predictable behavior data as an actual behavior state of the carrier if the current behavioral data are not equal to the predictable behavior data. The correction module's 33 comparison and correction of the current behavioral data and the predictable behavior data corrects the positioning data of the carrier if the current behavioral data are equal to the predictable behavior data, otherwise, if these two are not equal, gives different error correction by considering the four aforesaid erroneous causes. The solutions to these four causes are discussed next.

(1) The positioning data has errors caused by environment effects: the drift errors caused by the environmental effects may be used to correct the current behavioral data obtained through the predictable behavior data.

(2) The motion states of the carrier has changed: the accumulative number obtained by computing behavior changes being greater than an inertia parameter indicates that the motion states of the carrier have changed, and the current behavioral data obtained from the positioning data are adopted; on the contrary, if the accumulative number is not greater than the inertial parameter, only the predictable behavior data is used to correct the current behavioral data, as disclosed in the first condition.

(3) The prediction of the current state is incorrect: if the probability inferred is zero or is not the maximum and the state transition is undecided or there is more than one possibility of such a transition existing, two consecutive feature data have to be cross referred with the positioning data, wherein, if the error value is less than a threshold, the current behavioral data presented by the received positioning data is acceptable, or, otherwise, the previous perceived state is trusted based upon the law of inertia, that is the predictable behavior data adopted.

(4) The habitual behavior of the carrier has changed: the behavioral change of a carrier needs to be inferred by another suitable behavioral transition matrix. In practice, different habitual behaviors of a carrier may be classified according to velocity ranges denoted by (vᵢ−φᵢ, vᵢ+φᵢ), where vᵢ is the average speed of the habitual behaviors i, and φᵢ is the velocity range value. Accordingly, |v−vᵢ|≧φᵢ may be used to determine whether the habitual behaviors of a carrier have changed, that is taking a feature difference threshold as a determination basis. Of course, different behavioral transition matrixes have different feature difference thresholds.

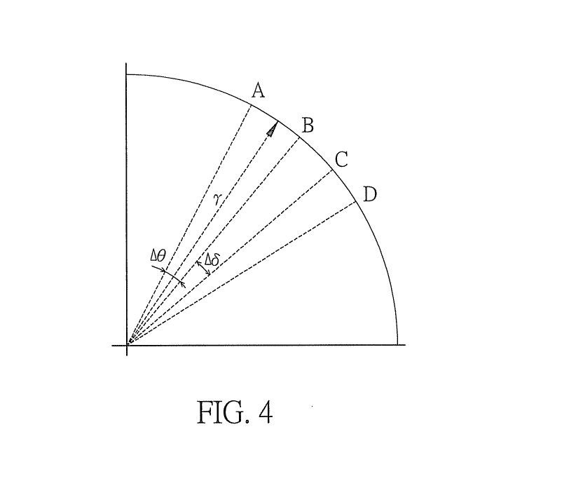

Since the positioning data is in a latitude and longitude format, a tangent line formula may be used by the processing unit 332 to correct errors of the positioning data. FIG. 4 illustrates how a perceptive global positioning device corrects errors of positioning data according to the present invention. In FIG. 4, a distance between two consecutive points is far smaller than the earth's radius (Δθ→0), and the distance of a tangent line AB may be expressed by 2r*tan(½)(Δθ)□rΔθ. Assuming that there are three consecutive location data points, A(λ_{A}, φ_{A}), B(λ_{B}, φ_{B}) and C(λ_{C}, φ_{C}), where λ is longitude data, and φ is latitude information, location D (λ_{D}, φ_{D}) may be calculated, according to the aforesaid tangent line formula and an inclusion angle relation between AB and BC, by the tangent line formula, as shown in equation (4),

λ_{D}=λ_{B}−λ_{A}+λ_{C}

φ_{D}=φ_{B}−φ_{A}+φ_{C} (4)

Moreover, the veering angle arcsin

$$θ ( \frac{{ϕ}_{D} - {ϕ}_{c}}{\sqrt{{( {ϕ}_{D} - {ϕ}_{c} )}^{2} + {( {λ}_{D} - {λ}_{c} )}^{2}}} )$$

of the carrier may be estimated by a Dead Reckoning formula and location D (λ_{D}, φ_{D}) and the previous location C(λ_{C}, φ_{C}).

Given the above, a perceptive global positioning device of the present invention uses positioning data to predict behavior states of a carrier, that is, calculating through a behavioral transition matrix (i.e., the optimal transition probability matrix, stable TPM, described in the embodiment), current positioning data and predecessor state data, predicting current possible behavior states of the carrier, and correcting errors, which are called perceptive global positioning (perceptive GPS). Moreover, the analysis module and/or the correction module and internal units thereof of the present invention may be realized by a software implementation.

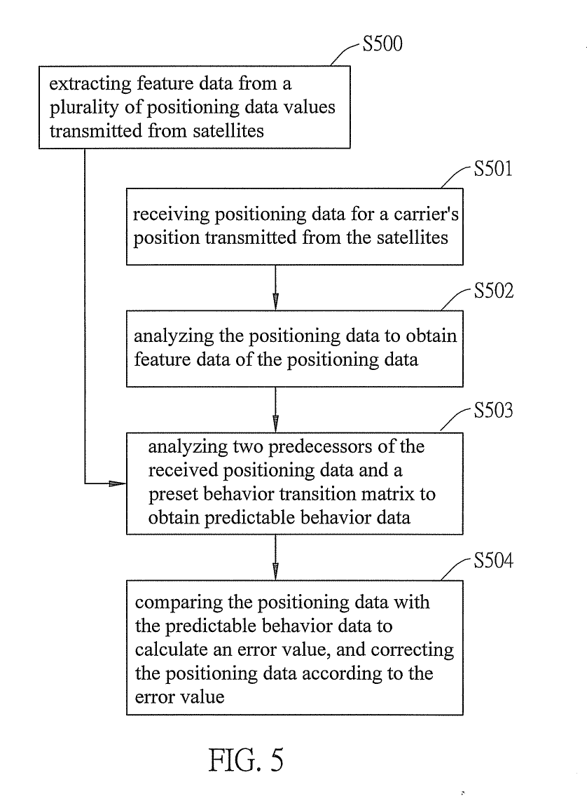

FIG. 5 is a flow chart of a perceptive global positioning method according to the present invention. As shown in FIG. 5, the method determines consecutive behavior states of a carrier according to positioning signals transmitted from a satellite, and corrects errors of the positioning data, which, in step S501, is positioning data of the carrier transmitted from the satellite. In other words, the perceptive global positioning device is installed on the carrier and continuously receives the positioning data transmitted from the satellite. Next, proceed to step S502.

In step S502, the positioning data is analyzed to obtain feature data of the positioning data. The received positioning data is analyzed, and feature data for navigation positioning purpose is obtained for subsequent behavior data prediction and error correction. Next, proceed to step S503.

In step S503, the two predecessors of the positioning data and a preset behavioral transition matrix are analyzed to obtain predictable behavior data. As described previously, it is necessary to know whether the positioning data has severe errors if it is desired to analyze and correct the positioning data. Behavior states are perceived through a behavioral transition matrix. Two previous positioning data sets are used to predict possible behavior states of the next position data set, for determination of the amount of an error value. Next, proceed to step S504.

In step S504, the positioning data is compared with the predictable behavior data to calculate the error value to correct the positioning data according to the error value. Through the comparison of the predictable behavior data perceived by the behavioral transition matrix with the received positioning data, the error value may be calculated, and errors of the positioning data may be corrected with regard to the error value.

In conclusion, the positioning data is compared with the predictable behavior data that is calculated through the preset behavioral transition matrix; error conditions that are generated according to the comparison provide the error correction to the positioning data. The embodiments are depicted in FIGS. 1-3, further description hereby omitted.

Additionally, in an embodiment of the present invention, before step S503, the method further comprises pre-executing the step S500 of generating the behavioral transition matrix, which means obtaining feature data from a plurality of positioning data values transmitted from a satellite, and substituting the feature data into a certain motion mechanics algorithm and probability algorithm to generate a behavioral transition matrix for behavior prediction purpose. The behavioral transition matrix is generated through a plurality of positioning data values in advance and by analyzing the behavior states for step S503 to obtain the predictable behavior states. In an embodiment, the certain motion mechanics algorithm applies Newton's laws of motion, and the probability algorithm may calculate probability through the Newton Markov Model (NMM). Note that the number of the behavioral transition matrixes is not limited to one, any number of behavioral transition matrixes may be generated, depending on the behavior state classification of the carrier, such that behaviors may be predicted under various behavior states of the carrier subsequently.

Since the carrier in different models may generate different behavioral transition matrixes to perceive the predictable behavior data, step S500 comprises classifying according to the feature data of the positioning data, that is classifying the various behavior models of the carrier, to generate the behavioral transition matrixes of different behavior states, to facilitate the accurate calculation of the predictable behavior data.

In yet another embodiment of the present invention, S504 includes generating current behavioral data by using the extracted feature data, comparing the current behavioral data with the predictable behavior data, and correcting positioning data of the carrier according to the predictable behavior data if the current behavioral data equals to the predictable behavior data, or selecting one of the current behavioral data and the predictable behavior data as an actual behavior state of the carrier if the current behavioral data does not equal to the predictable behavior data. Simply speaking, error conditions between the predictable behavior data and the received positioning data are corrected.

The error correction method is classified into three processing conditions. The error value is determined whether it is in a reasonable state based on a preset error threshold. When an error value is less than the preset error threshold, the actual received positioning data has small errors, or the received positioning data is considered to have too much error. Accordingly, the causes that generate the errors may be analyzed and errors are then corrected. The three states are described as follows.

The first one is that the current behavioral data equals to the predictable behavior data, and the positioning data are finely corrected, to prevent the occurrence of accumulative errors generated by the plurality of positioning data values. In practice, the error value between the positioning data and the predictable behavior data does not exceed the error threshold, such that positioning data may be finely adjusted as the next positioning data.

The second one is when the current behavioral data is not equal to the predictable behavior data and it is determined that the error of the positioning data has been detected, wherein the predictable behavior data is selected to replace the actual behavior state of the carrier. In more detail, when the current behavioral data is compared with the predictable behavior data and their error value is greater than the error threshold, start to record a count, and if the count is greater than a preset posture threshold, which indicates that the received positioning data is not correct, replace the positioning data with the predictable behavior data as the actual behavior state of the carrier. Further, the predictable behavior data is finely adjusted, such that the actual behavior state is more appropriate.

The third one is that if the current behavioral data is not equal to the predictable behavior data and it is determined that the carrier has changed its behavior state, the current behavioral data is selected as the actual behavior states of the carrier, indicating that, if the error value from the current behavioral data and the predictable behavior data is greater than the error threshold and the count is greater than a certain number, the carrier has apparently changed its original behavior state. For example, the carrier in the veering deceleration state originally has changed to the linear acceleration state. Accordingly, the predictable behavior data perceived through the original behavioral transition matrix cannot express the current state of the carrier, and the received positioning data is the actual behavior state of the carrier and is finely adjusted.

In conclusion, the present invention provides a perceptive global positioning device and method that, after extracting the feature data of positioning data transmitted from a satellite, calculates possible behavior states of the carrier through an optimal behavioral transition matrix, determines an error value between the currently received positioning data and possible behavior information, and corrects errors of the positioning data. By adding the sense data analysis of the carrier, the predictable behavior states of the carrier may be obtained, compared and corrected. The accuracy of positioning effect may be improved accordingly. Hence, problems of conventional global positioning devices may be solved, the problem of the prior art is solved that adding navigation equipment may increase the cost and introduce errors, and the global positioning effect is greatly improved.

What the claimed is:

1. A perceptive global positioning device that is disposed on a carrier, for receiving positioning signals transmitted from satellites, in order to detect behavior states of the carrier and correct errors in positioning data of the carrier, the perceptive global positioning device comprising:
a sensor for receiving positioning data of the carrier transmitted from the satellites;
a database for storing the positioning data received by the sensor and a preset behavioral transition matrix of the carrier;
an analysis module for analyzing the positioning data and the behavioral transition matrix to acquire predictable behavior data of the carrier; and
a correction module that compares the predictable behavior data of the carrier with the positioning data to correct errors in the positioning data of the carrier.

2. The perceptive global positioning device of claim 1, wherein the analysis module comprises:
an extraction unit for extracting from the positioning data feature data including a displacement, velocity difference and course difference of the carrier during a motion period;
a switching unit for analyzing the feature data according to a carrier habitual behavior determination rule, to switch thresholds corresponding to feature data of the carrier's habitual behaviors and the behavioral transition matrix corresponding to the carrier's habitual behaviors; and
a perceiving unit for analyzing behavior states of two predecessors of positioning data received by the sensor, and calculating the predictable behavior data through the behavioral transition matrix.

3. The perceptive global positioning device of claim 2, wherein the analysis module classifies the behavior states of the carrier into a stationary model, a linear cruise model, a linear acceleration model, a linear deceleration model, a veering cruise model, a veering acceleration model and/or a veering deceleration model according to different feature data of the carrier, and the analysis module generates at least one determination result, to enable the processing unit to correct errors in the corresponding positioning data according to at least one determination result, the determination result comprising errors generated by the positioning data due to environmental factors, a change of a motion state of the carrier, errors of the predictable behavior data and a change of the habitual behaviors of the carrier.

4. The perceptive global positioning device of claim 1, wherein the correction module comprises:
an error unit for calculating an error value of the positioning data according to the predictable behavior data; and
a processing unit for correcting the errors of the positioning data according to the error value.

5. The perceptive global positioning device of claim 2, wherein the correction module generates current behavioral data by using the extracted feature data, compares the current behavioral data with the predictable behavior data, and corrects the positioning data of the carrier according to the predictable behavior data if the current behavioral data does not equal to the predictable behavior data, or selects one of the current behavioral data and the predictable behavior data as an actual behavior state of the carrier through a certain state determining rule if the current behavioral data is not equal to the predictable behavior data.

6. The perceptive global positioning device of claim 1, wherein the analysis module and/or the correction module are realized by a software mechanism.

7. A perceptive global positioning method for determining consecutive behavior states of a carrier through positioning signals transmitted from satellites and correcting errors of the positioning data, the method comprising the following steps of:
(1) receiving positioning data transmitted from the satellites to the carrier;
(2) analyzing the positioning data to obtain feature data of the positioning data;
(3) analyzing two predecessors of the received positioning data and a preset behavioral transition matrix to obtain predictable behavior data; and
(4) comparing the positioning data with the predictable behavior data to calculate an error value, and correcting the positioning data according to the error value.

8. The method of claim 7, further comprising, before the execution of step (3), obtaining the feature data from the plurality of positioning data transmitted from the satellites, and substituting the feature data into a certain motion mechanics algorithm and probability algorithm to generate a behavioral transition matrix for predicting behaviors.

9. The method of claim 8, wherein generating a behavioral transition matrix comprises classifying the feature data to generate behavioral model data of the carrier, and performing calculations based on the behavioral model data to generate the behavioral transition matrix.

10. The method of claim 7, wherein step (4) comprises: generating current behavioral data by using the feature data, comparing the current behavioral data with the predictable behavior data, and correcting the positioning data of the carrier according to the predictable behavior data if the current behavioral data equals to the predictable behavior data, or selecting one of the current behavioral data and the predictable behavior data as an actual behavior state of the carrier if the current behavioral data is not equal to the predictable behavior data.

11. The method of claim 10, wherein, if the current behavioral data is equal to the predictable behavior data, the positioning data is finely tuned to prevent accumulated errors generated by the positioning data; if the current behavioral data is not equal to the predictable behavior data, and errors in the positioning data are detected, the predictable behavior data is selected as the actual behavior state of the carrier; if the current behavioral data is not equal to the predictable behavior data, and the carrier has changed the behavior states, the current behavioral data is selected as the actual behavior state of the carrier.
